(19) United States
(12) Patent Application Publication
(10) Pub. No.: US 2026/0058733 A1
(43) Pub. Date: Feb. 26, 2026

(54) DYNAMIC POWER CONSUMPTION MANAGEMENT SYSTEM

(71) Applicant: JOYWELL SEMICONDUCTOR (SHANGHAI) CO., LTD., Shanghai (CN)

(72) Inventors: Yongheng HUANG, Shanghai (CN); Hui WANG, Shanghai (CN); Haonan WANG, Shanghai (CN)

(21) Appl. No.: 19/129,573

(22) PCT Filed: Nov. 3, 2023
(86) PCT No.: PCT/CN2023/129675

§ 371 Date: May 13, 2025

(30) Foreign Application Priority Data
Nov. 14, 2022 (CN) 202211426734.7

(51) Int. Cl. H04B 10/80; H04B 10/61

(52) U.S. Cl. CPC H04B 10/806; H04B 10/613; H04B 10/6164; H04B 10/6165

(57) ABSTRACT

The present application discloses a dynamic power consumption management system, comprising: an equalization algorithm circuit, a carrier recovery algorithm circuit, and an IQ imbalance algorithm circuit; an equalization algorithm coefficient update circuit connected to an output end of the carrier recovery algorithm circuit and configured to provide equalization algorithm update coefficients to the equalization algorithm circuit; a carrier recovery frequency offset and phase noise calculation circuit connected to an output end of the equalization algorithm circuit and configured to provide carrier recovery frequency offset and phase noise coefficients to the carrier recovery algorithm circuit; an IQ imbalance algorithm coefficient update circuit connected to an output end of the IQ imbalance algorithm circuit and configured to provide IQ imbalance algorithm coefficients to the IQ imbalance algorithm circuit; a signal-to-noise ratio reporting circuit connected to an output end of the IQ imbalance algorithm circuit and configured to acquire a signal-to-noise ratio of the entire system; and a management circuit configured to determine the equalization algorithm update coefficients, the carrier recovery frequency offset and phase noise coefficients, and the IQ imbalance algorithm coefficients based on the signal-to-noise ratio. The present application can reduce the power consumption of chips.

### TECHNICAL FIELD

The present application relates to the field of coherent optical communication chips, particularly to a dynamic power consumption management system.

### BACKGROUND

Coherent optical chips play an important role in optical communication. They are mainly applied in long-distance and high-capacity communication scenarios. In recent years, with the gradual increase in communication capacity and accuracy requirements, there has also been a demand for coherent technology to be deployed in short-distance data center scenarios, with the 400G ZR communication protocol being one representative of this demand. In the research of coherent optical chips, in addition to the continuous pursuit of performance improvement, low power consumption is also one of the important research directions. Reducing chip power consumption can significantly lower the heat dissipation cost of optical modules and the operating cost of optical module application vendors.

The equalization algorithm circuit, carrier recovery algorithm circuit, and IQ imbalance circuit are indispensable and important components in high-performance coherent optical chips. However, the power consumption of these three algorithm circuits accounts for a relatively large proportion of the overall optical chip power consumption, so it is necessary to carry out relevant research on the low-power consumption technology of the three algorithm circuits.

The research hierarchy for low-power technology can be divided into system level, behavioral level, RTL level, logic level, and physical level. The lower the hierarchy, the closer to the underlying implementation of the circuit, the greater the generality of the related low-power methods, but the smaller the optimization potential; the higher the hierarchy, the closer to the top-level algorithm design, and the greater the optimization potential.

### SUMMARY OF THE INVENTION

An object of the present application is to provide a dynamic power consumption management system that significantly reduces chip power consumption.

The application discloses a dynamic power consumption management system, comprising:
an equalization algorithm circuit, a carrier recovery algorithm circuit, and an IQ imbalance algorithm circuit, the equalization algorithm circuit, the carrier recovery algorithm circuit, and the IQ imbalance algorithm circuit being sequentially connected and forming a main data path;
an equalization algorithm coefficient update circuit connected to an output end of the carrier recovery algorithm circuit and configured to provide equalization algorithm update coefficients to the equalization algorithm circuit;
a carrier recovery frequency offset and phase noise calculation circuit connected to an output end of the equalization algorithm circuit and configured to provide carrier recovery frequency offset and phase noise coefficients to the carrier recovery algorithm circuit;
an IQ imbalance algorithm coefficient update circuit connected to an output end of the IQ imbalance algorithm circuit and configured to provide IQ imbalance algorithm coefficients to the IQ imbalance algorithm circuit;
a signal-to-noise ratio reporting circuit connected to the output end of the IQ imbalance algorithm circuit and acquires a signal-to-noise ratio of the entire system; and
a management circuit which is coupled to the signal-to-noise ratio reporting circuit, the equalization algorithm coefficient update circuit, the carrier recovery frequency offset and phase noise calculation circuit, and the IQ imbalance algorithm coefficient update circuit, and determines the equalization algorithm update coefficients, the carrier recovery frequency offset and phase noise coefficients, and the IQ imbalance algorithm coefficients based on the signal-to-noise ratio.

In a preferred embodiment, the management circuit determines which preset signal-to-noise ratio threshold range the acquired signal-to-noise ratio falls within, to determine an update strategy as follows:
if the signal-to-noise ratio is greater than a first threshold, the management circuit determines that the equalization algorithm update coefficient is updated every 8 clocks, the IQ imbalance algorithm coefficient is updated every 16 clocks, and the carrier recovery frequency offset and phase noise coefficients are updated every 4 clocks;
if the signal-to-noise ratio is greater than a second threshold and less than or equal to the first threshold, the management circuit determines that the equalization algorithm update coefficient is updated every 6 clocks, the IQ imbalance algorithm coefficient is updated every 12 clocks, and the carrier recovery frequency offset and phase noise coefficients are updated every 3 clocks;
if the signal-to-noise ratio is greater than a third threshold and less than or equal to the second threshold, the management circuit determines that the equalization algorithm update coefficient is updated every 4 clocks, the IQ imbalance algorithm coefficient is updated every 8 clocks, and the carrier recovery frequency offset and phase noise coefficients are updated every 2 clocks; and
if the signal-to-noise ratio is less than the third threshold, the management circuit determines that the equalization algorithm update coefficient is updated every 2 clocks, the IQ imbalance algorithm coefficient is updated every 4 clocks, and the carrier recovery frequency offset and phase noise coefficients are updated every 1 clock.

In a preferred embodiment, the management circuit determines which preset signal-to-noise ratio threshold range the acquired signal-to-noise ratio falls within, to determine an update strategy as follows:
if the signal-to-noise ratio is greater than a first threshold, the management circuit determines that: during the 1st-4th clocks, the equalization algorithm update coefficient is updated every 2 clocks, the IQ imbalance algorithm coefficient is updated every 4 clocks, and the carrier recovery frequency offset and phase noise coefficients are updated every 1 clock; during the 5th-20th clocks, the equalization algorithm update coefficient is updated every 4 clocks, the IQ imbalance algorithm coefficient is updated every 8 clocks, and the carrier recovery frequency offset and phase noise coefficients are updated every 2 clocks; during the 21st-32nd clocks, the equalization algorithm update coefficient is updated every 6 clocks, the IQ imbalance algorithm coefficient is updated every 12 clocks, and the carrier recovery frequency offset and phase noise coefficients are updated every 3 clocks; during the 33rd-48th clocks, the equalization algorithm update coefficient is updated every 8 clocks, the IQ imbalance algorithm coefficient is updated every 16 clocks, and the carrier recovery frequency offset and phase noise coefficients are updated every 4 clocks; and then repeats this sequence cyclically;
if the signal-to-noise ratio is greater than a second threshold and less than or equal to the first threshold, the management circuit determines that: during the 1st-8th clocks, the equalization algorithm update coefficient is updated every 2 clocks, the IQ imbalance algorithm coefficient is updated every 4 clocks, and the carrier recovery frequency offset and phase noise coefficients are updated every 1 clock; during the 9th-16th clocks, the equalization algorithm update coefficient is updated every 4 clocks, the IQ imbalance algorithm coefficient is updated every 8 clocks, and the carrier recovery frequency offset and phase noise coefficients are updated every 2 clocks; during the 17th-28th clocks, the equalization algorithm update coefficient is updated every 6 clocks, the IQ imbalance algorithm coefficient is updated every 12 clocks, and the carrier recovery frequency offset and phase noise coefficients are updated every 3 clocks; during the 29th-44th clocks, the equalization algorithm update coefficient is updated every 8 clocks, the IQ imbalance algorithm coefficient is updated every 16 clocks, and the carrier recovery frequency offset and phase noise coefficients are updated every 4 clocks; and then repeats this sequence cyclically;
if the signal-to-noise ratio is greater than a third threshold and less than or equal to the second threshold, the management circuit determines that: during the 1st-8th clocks the equalization algorithm update coefficient is updated every 2 clocks, the IQ imbalance algorithm coefficient is updated every 4 clocks, and the carrier recovery frequency offset and phase noise coefficients are updated every 1 clock; during the 9th-16th clocks, the equalization algorithm update coefficient is updated every 4 clocks, the IQ imbalance algorithm coefficient is updated every 8 clocks, and the carrier recovery frequency offset and phase noise coefficients are updated every 2 clocks; during the 17th-28th clocks, the equalization algorithm update coefficient is updated every 6 clocks, the IQ imbalance algorithm coefficient is updated every 12 clocks, and the carrier recovery frequency offset and phase noise coefficients are updated every 3 clocks; and then repeats this sequence cyclically; and
if the signal-to-noise ratio is less than the third threshold, the management circuit determines that: during the 1st-8th clocks, the equalization algorithm update coefficient is updated every 2 clocks, the IQ imbalance algorithm coefficient is updated every 4 clocks, and the carrier recovery frequency offset and phase noise coefficients are updated every 1 clock; during the 9th-16th clocks, the equalization algorithm update coefficient is updated every 4 clocks, the IQ imbalance algorithm coefficient is updated every 8 clocks, and the carrier recovery frequency offset and phase noise coefficients are updated every 2 clocks; and then repeats this sequence cyclically.

In a preferred embodiment, the system further comprises:
a parameter acquisition circuit, configured to acquire sequence BER, DGD, PDL, and SOP of the entire system;
a protection circuit coupled to the parameter acquisition circuit, the signal-to-noise ratio reporting circuit, and the management circuit, wherein if any one of the sequence BER, DGD, PDL, and SOP is greater than a corresponding threshold, or the signal-to-noise ratio is less than a corresponding threshold, or an absolute value of a difference between two consecutive measured values of any one of the signal-to-noise ratio, the sequence BER, DGD, PDL, and SOP is greater than a corresponding threshold, the protection circuit deactivates the management circuit; and if each of the sequence BER, DGD, PDL, and SOP is less than or equal to a corresponding threshold, and the signal-to-noise ratio is greater than or equal to a corresponding threshold, and the absolute value of the difference between two consecutive measured values of any one of the signal-to-noise ratio, the sequence BER, DGD, PDL, and SOP is less than or equal to a corresponding threshold, the protection circuit activates the management circuit.

In a preferred embodiment, the equalization algorithm coefficient update circuit performs updating based on the equalization algorithm update coefficient determined by the management circuit, and is deactivated during clock cycles when not updating.

In a preferred embodiment, the IQ imbalance algorithm coefficient update circuit performs updating based on the IQ imbalance algorithm coefficient determined by the management circuit, and is deactivated during clock cycles when not updating.

In a preferred embodiment, the carrier recovery frequency offset and phase noise calculation circuit performs updating based on the frequency offset and phase noise coefficients determined by the management circuit, and provides the phases noise coefficients by using a linear interpolation method during clock cycles when not updating.

In embodiments of the present application, a new dynamic power consumption management method is proposed, which can achieve significant power consumption reduction at the cost of a small accuracy loss. The dynamic power consumption management method acts on the equalization algorithm circuit, the carrier recovery algorithm circuit, and the IQ imbalance algorithm circuit, and is suitable for use in coherent optical communication chips.

A large number of technical features are described in the specification of the present application, and are distributed in various technical solutions. If a combination (i.e., a technical solution) of all possible technical features of the present application is listed, the description may be made too long. In order to avoid this problem, the various technical features disclosed in the above summary of the present application, the technical features disclosed in the various embodiments and examples below, and the various technical features disclosed in the drawings can be freely combined with each other to constitute various new technical solutions (all of which are considered to have been described in this specification), unless a combination of such technical features is not technically feasible. For example, feature A+B+C is disclosed in one example, and feature A+B+D+E is disclosed in another example, while features C and D are equivalent technical means that perform the same function, and technically only choose one, not to adopt at the same time. Feature E can be combined with feature C technically. Then, the A+B+C+D scheme should not be regarded as already recorded because of the technical infeasibility, and A+B+C+E scheme should be considered as already documented.

### BRIEF DESCRIPTION OF THE FIGURES

FIG. 1 is a schematic diagram of a dynamic power consumption management system according to an embodiment of the present application.

FIG. 2 is a schematic diagram of an update strategy according to an embodiment of the present application.

FIG. 3 is a schematic diagram of an update strategy according to another embodiment of the present application.

FIG. 4 is a schematic diagram of a Wiener process according to an embodiment of the present application.

### DETAILED DESCRIPTION

In the following description, numerous technical details are set forth in order to provide the readers with a better understanding of the present application. However, those skilled in the art can understand that the technical solutions claimed in the present application can be implemented without these technical details and various changes and modifications based on the following embodiments.

Explanation of some concepts:
Equalization algorithm: the equalization algorithm is applied in coherent optical chip circuits to recover signals with compromised accuracy after passing through optical devices and fibers. Its input is a baseband digital signal with device and channel damage, and its output is a recovered baseband digital signal.
Carrier recovery algorithm: the carrier recovery algorithm is typically applied in coherent optical chip circuits to recover signals with frequency offset and phase noise after passing through lasers.
IQ imbalance algorithm: the IQ imbalance algorithm is typically applied in coherent optical chip circuits to recover signals with IQ imbalance after passing through optical devices.

In order to make the objects, technical solutions and advantages of the present application clearer, embodiments of the present application will be further described in detail below with reference to the accompanying drawings.

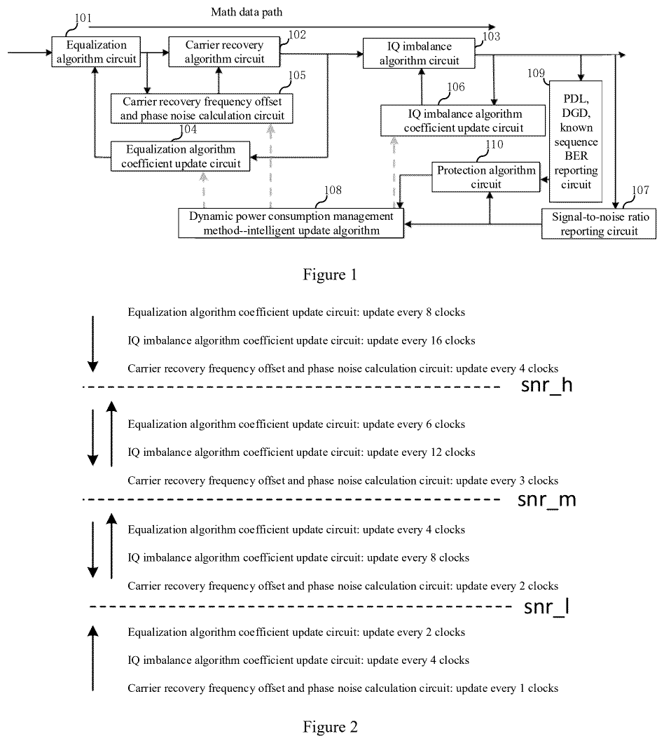

A first embodiment of the present application relates to a dynamic power consumption management system, as shown in FIG. 1. The system comprises: an equalization algorithm circuit 101, a carrier recovery algorithm circuit 102, an IQ imbalance algorithm circuit 103, an equalization algorithm coefficient update circuit 104, a carrier recovery frequency offset and phase noise calculation circuit 105, an IQ imbalance algorithm coefficient update circuit 106, a signal-to-noise ratio reporting circuit 107, and a management circuit 108.

The equalization algorithm circuit 101, the carrier recovery algorithm circuit 102, and the IQ imbalance algorithm circuit 103 are sequentially connected and form a main data path. The equalization algorithm coefficient update circuit 104 is connected to an output end of the carrier recovery algorithm circuit 102 and provides equalization algorithm update coefficients to the equalization algorithm circuit 101. The carrier recovery frequency offset and phase noise calculation circuit 105 is connected to an output end of the equalization algorithm circuit 101 and provides carrier recovery frequency offset and phase noise coefficients to the carrier recovery algorithm circuit 102. The IQ imbalance algorithm coefficient update circuit 106 is connected to an output end of the IQ imbalance algorithm circuit 103 and provides IQ imbalance algorithm coefficients to the IQ imbalance algorithm circuit 103. The signal-to-noise ratio reporting circuit 107 is connected to the output end of the IQ imbalance algorithm circuit 103 and used to acquire a signal-to-noise ratio (SNR) snr_report of the entire system. The management circuit 108 is coupled to the signal-to-noise ratio reporting circuit 107, the equalization algorithm coefficient update circuit 104, the carrier recovery frequency offset and phase noise calculation circuit 105, and the IQ imbalance algorithm coefficient update circuit 106, and determines the equalization algorithm update coefficients, the carrier recovery frequency offset and phase noise coefficients, and the IQ imbalance algorithm coefficients based on the signal-to-noise ratio snr_report.

Referring to FIG. 2, the management circuit 108 determines which preset signal-to-noise ratio threshold range the acquired signal-to-noise ratio snr_report falls within, to determine an update strategy as follows:
if the signal-to-noise ratio snr_report is greater than a first threshold snr_h, the management circuit 108 determines that the equalization algorithm update coefficient is updated every 8 clocks, the IQ imbalance algorithm coefficient is updated every 16 clocks, and the carrier recovery frequency offset and phase noise coefficients are updated every 4 clocks;
if the signal-to-noise ratio snr_report is greater than a second threshold snr_m and less than or equal to the first threshold snr_h, the management circuit determines that the equalization algorithm update coefficient is updated every 6 clocks, the IQ imbalance algorithm coefficient is updated every 12 clocks, and the carrier recovery frequency offset and phase noise coefficients are updated every 3 clocks;
if the signal-to-noise ratio snr_report is greater than a third threshold snr_l and less than or equal to the second threshold snr_m, the management circuit 108 determines that the equalization algorithm update coefficient is updated every 4 clocks, the IQ imbalance algorithm coefficient is updated every 8 clocks, and the carrier recovery frequency offset and phase noise coefficients are updated every 2 clocks; and if the signal-to-noise ratio snr_report is less than the third threshold snr_l, the management circuit 108 determines that the equalization algorithm update coefficient is updated every 2 clocks, the IQ imbalance algorithm coefficient is updated every 4 clocks, and the carrier recovery frequency offset and phase noise coefficients are updated every 1 clock.

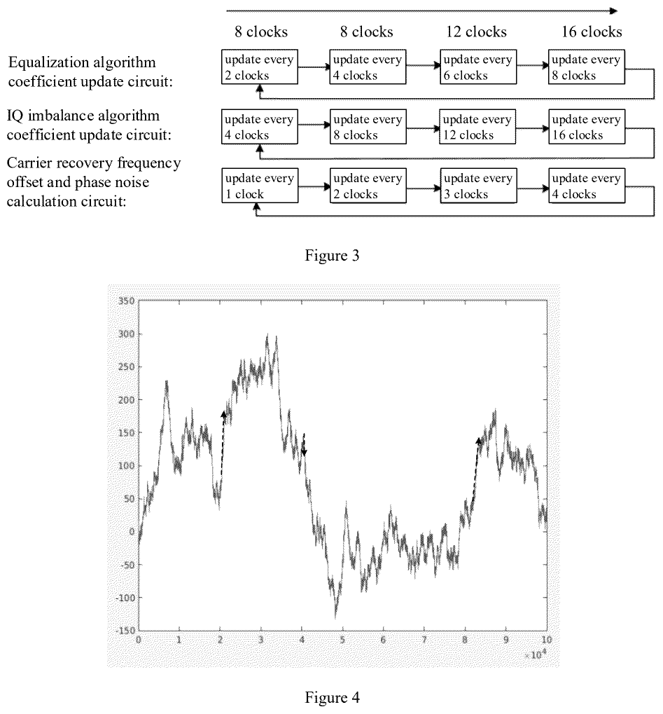

Referring to FIG. 3, in another embodiment, the management circuit 108 determines which preset signal-to-noise ratio threshold range the acquired signal-to-noise ratio snr_report falls within, to determine an update strategy as follows:
if the signal-to-noise ratio snr_report is greater than a first threshold snr_h, the management circuit determines that during the 1st-4th clocks, the equalization algorithm update coefficient is updated every 2 clocks, the IQ imbalance algorithm coefficient is updated every 4 clocks, and the carrier recovery frequency offset and phase noise coefficients are updated every 1 clock; during the 5th-20th clocks, the equalization algorithm update coefficient is updated every 4 clocks, the IQ imbalance algorithm coefficient is updated every 8 clocks, and the carrier recovery frequency offset and phase noise coefficients are updated every 2 clocks; during the 21st-32nd clocks, the equalization algorithm update coefficient is updated every 6 clocks, the IQ imbalance algorithm coefficient is updated every 12 clocks, and the carrier recovery frequency offset and phase noise coefficients are updated every 3 clocks; during the 33rd-48th clocks, the equalization algorithm update coefficient is updated every 8 clocks, the IQ imbalance algorithm coefficient is updated every 16 clocks, and the carrier recovery frequency offset and phase noise coefficients are updated every 4 clocks. And, the management circuit 108 updates cyclically according to the above method.
if the signal-to-noise ratio snr_report is greater than a second threshold snr_m and less than or equal to the first threshold snr_h, the management circuit determines that during the 1st-8th clocks, the equalization algorithm update coefficient is updated every 2 clocks, the IQ imbalance algorithm coefficient is updated every 4 clocks, and the carrier recovery frequency offset and phase noise coefficients are updated every 1 clock; during the 9th-16th clocks, the equalization algorithm update coefficient is updated every 4 clocks, the IQ imbalance algorithm coefficient is updated every 8 clocks, and the carrier recovery frequency offset and phase noise coefficients are updated every 2 clocks; during the 17th-28th clocks, the equalization algorithm update coefficient is updated every 6 clocks, the IQ imbalance algorithm coefficient is updated every 12 clocks, and the carrier recovery frequency offset and phase noise coefficients are updated every 3 clocks; during the 29th-44th clocks, the equalization algorithm update coefficient is updated every 8 clocks, the IQ imbalance algorithm coefficient is updated every 16 clocks, and the carrier recovery frequency offset and phase noise coefficients are every 4 clocks. And, the management circuit 108 updates cyclically according to the above method.
if the signal-to-noise ratio snr_report is greater than a third threshold snr_l and less than or equal to the second threshold snr_m, the management circuit determines that during the 1st-8th clocks, the equalization algorithm update coefficient is updated every 2 clocks, the IQ imbalance algorithm coefficient is updated every 4 clocks, and the carrier recovery frequency offset and phase noise coefficients are updated every 1 clock; during the 9th-16th clocks, the equalization algorithm update coefficient is updated every 4 clocks, the IQ imbalance algorithm coefficient is updated every 8 clocks, and the carrier recovery frequency offset and phase noise coefficients are updated every 2 clocks; during the 17th-28th clocks, the equalization algorithm update coefficient is updated every 6 clocks, the IQ imbalance algorithm coefficient is updated every 12 clocks, and the carrier recovery frequency offset and phase noise coefficients are updated every 3 clocks. And, the management circuit 108 updates cyclically according to the above method.
if the signal-to-noise ratio snr_report is less than the third threshold snr_l, the management circuit determines that during the 1st-8th clocks, the equalization algorithm update coefficient is updated every 2 clocks, the IQ imbalance algorithm coefficient is updated every 4 clocks, and the carrier recovery frequency offset and phase noise coefficients are updated every 1 clock; during the 9th-16th clocks, the equalization algorithm update coefficient is updated every 4 clocks, the IQ imbalance algorithm coefficient is updated every 8 clocks, and the carrier recovery frequency offset and phase noise coefficients are updated every 2 clocks. And, the management circuit 108 updates cyclically according to the above method.

In one embodiment, the equalization algorithm coefficient update circuit 104 performs updating based on the equalization algorithm update coefficient determined by the management circuit, and is deactivated during clock cycles when not updating.

In one embodiment, the IQ imbalance algorithm coefficient update circuit 106 performs updating based on the IQ imbalance algorithm coefficient determined by the management circuit, and is deactivated during clock cycles when not updating.

In one embodiment, the carrier recovery frequency offset and phase noise calculation circuit 105 performs updating based on the frequency offset and phase noise coefficients determined by the management circuit, and provides the phase noise coefficients by using a linear interpolation method during clock cycles when not updating.

In one embodiment, the system further comprises a parameter acquisition circuit 109 and a protection circuit 110. The parameter acquisition circuit 109 is used to acquire the sequence bit error rate (BER), differential group delay (DGD), polarization dependent loss (PDL), and state of polarization (SOP) of the entire system. The protection circuit 110 is coupled to the parameter acquisition circuit 109, the signal-to-noise ratio reporting circuit 107, and the management circuit 108. If any of the sequence BER, DGD, PDL, and SOP is greater than the corresponding threshold, or if the signal-to-noise ratio is less than the corresponding threshold, or if the absolute value of the difference between the two consecutive measured values of any of the signal-to-noise ratio, and the sequence BER, DGD, PDL, and SOP is greater than the corresponding threshold, the protection circuit deactivates the management circuit. If each of the sequence BER, DGD, PDL, and SOP is less than or equal to the corresponding threshold, and the signal-to-noise ratio is greater than or equal to the corresponding threshold, and the absolute value of the difference between the two consecutive measured values of any of the signal-to-noise ratio, and the sequence BER, DGD, PDL, and SOP is less than or equal to the corresponding threshold, the protection circuit activates the management circuit.

In order to better understand the technical solutions of this specification, the following description will be given with a specific embodiment. The details listed in this embodiment are mainly for ease of understanding and are not intended to limit the scope of protection of this application.

The overall schematic diagram of the dynamic power consumption management method proposed in this solution is shown in FIG. 1. The equalization algorithm circuit 101, the carrier recovery algorithm circuit 102, and the IQ imbalance algorithm circuit 103 constitute the main data path. Both the equalization algorithm and IQ imbalance algorithm have corresponding coefficient update circuits, and the carrier recovery algorithm has corresponding frequency offset and phase noise calculation circuit. At the output of the main data path, there is also a signal-to-noise ratio reporting circuit 107. The dynamic power consumption management circuit 108 acts on two coefficient update circuits 104, 106 and the frequency offset and phase noise calculation circuit 105. In prior art solutions, these three circuits 104-106 are updated in each clock cycle upon data arrival (the coefficient update circuits of the equalization algorithm and IQ imbalance algorithm may be updated over multiple clocks) to ensure system performance. The coefficient update circuit and the frequency offset and phase noise calculation circuit involve operations such as multiplication and interpolation, which have a relatively large power consumption share. Therefore, reducing their update frequency (i.e., not operating at certain times) can proportionally reduce the power consumption of the corresponding algorithm circuit. The protection circuit 110 can control the intelligent update algorithm to ensure the robustness of the system.

This solution designs two sets of intelligent update algorithms, which can effectively reduce the update speed of the three circuits 104-106, while ensuring that the system performance does not degrade significantly and still meets system requirements.

### Method 1: Adaptive Threshold Update Method.

Based on product definition and requirements, three SNR thresholds, snr_h, snr_m, and snr_l, are determined, which represent the three SNR requirements of high performance, balance and low power consumption respectively. As shown in FIG. 2, different update strategies are adopted within different SNR threshold ranges. When the SNR of the system is higher, the update frequency is automatically reduced in exchange for greater system power consumption benefits. The SNR of the system is obtained from the signal-to-noise ratio reporting circuit.

### Method 2: Alternating Update Mode

A fixed number of clocks (one clock cycle) is used to control the update speed. Initially, a faster update speed is adopted, then the update speed is gradually reduced, and then it is switched back to a faster update speed. At a faster update speed, the coefficients can converge rapidly and the frequency offset and phase noise can be tracked quickly to ensure performance; at a lower update frequency, the system performance can be basically maintained and power consumption can be rapidly reduced. Similarly, based on product definition and requirements, three SNR thresholds, snr_h, snr_m, and snr_l, are determined, which represent the three SNR requirements of high performance, balance and low power consumption respectively. Different update strategies are adopted in different snr threshold ranges. When the reported snr_report is greater than snr_h, updating is performed in the sequence of [4 clocks->16 clocks->12 clocks->16 clocks]; when the reported snr_report is in the range of snr_h to snr_m, updating is performed in the sequence of [8 clocks->8 clocks->12 clocks->16 clocks]; when the reported snr_report is in the range of snr_m to snr_l, updating is performed in the sequence of [8 clocks->8 clocks->12 clocks->0 clocks]; when the reported snr_report is less than snr_l, updating is performed in the sequence of [8 clocks->8 clocks->0 clocks->0 clocks].

The update coefficients of each update stage are: in the first 4 clocks, the equalization algorithm update coefficient is updated every 2 clocks, the IQ imbalance algorithm coefficient is updated every 4 clocks, and the carrier recovery frequency offset and phase noise coefficients are updated every 1 clock; in the next 16 clocks, the equalization algorithm update coefficient is updated every 4 clocks, the IQ imbalance algorithm coefficient is updated every 8 clocks, and the carrier recovery frequency offset and phase noise coefficients are updated every 2 clocks; in the next 12 clocks, the equalization algorithm update coefficient is updated every 6 clocks, the IQ imbalance algorithm coefficient is updated every 12 clocks, and the carrier recovery frequency offset and phase noise coefficients are updated every 3 clocks; in the next 16 clocks, the equalization algorithm update coefficient is updated every 8 clocks, the IQ imbalance algorithm coefficient is updated every 16 clocks, and the carrier recovery frequency offset and phase noise coefficients are updated every 4 clocks. FIG. 3 shows the situation when the reported snr_report is in the range of snr_h to snr_m. The number of clocks in each stage will continue to accumulate until it is cleared after the update and restarted in a stage. 0 clocks represent not entering this stage.

Update method: the update method of the equalization algorithm coefficient and the IQ imbalance algorithm coefficient is relatively simple. The update circuit can be directly deactivated by the enable signal, and the coefficients can be kept at the value after the last update. The phase noise update of the carrier recovery algorithm must be processed accordingly because the continuity of the signal phase is taken into account. The signal modulation format transmitted in the coherent optical chip is generally a high-order modulation signal such as QPSK, 16QAM, 64QAM, etc., which consists of a real part and an imaginary part, dout=a+b*j, so there is a phase arctan(b/a). Frequency offset (frequency drift caused by laser) does not involve the concept of phase continuity, so the frequency offset value calculated last time can be directly maintained.

Phase noise is also generated by the laser and is a Wiener process (the increments follow a Gaussian distribution). FIG. 4 shows a schematic diagram of a Wiener process, where the increment follows a Gaussian distribution with a mean of 0 and a standard deviation of 1. In general, the phase noise can be solved by using a standard algorithm to obtain the phase noise of some intermediate symbols, and then using a linear interpolation method to obtain the phase noise of the symbols between these symbols, as shown by the black straight line in FIG. 4. Obviously, when updating over multiple clocks, for the data symbols of the clocks that are not updated, the phase noise cannot be obtained by simply holding the value, but should be calculated by continuing interpolation based on the previously known interpolation slope to obtain the corresponding phase noise.

It should be noted that in this specification of the application, relational terms such as the first and second, and so on are only configured to distinguish one entity or operation from another entity or operation, and do not necessarily require or imply any such actual relationship or order between these entities or operations. Furthermore, the term “comprises” or “comprising” or “includes” or any other variations thereof is intended to encompass a non-exclusive inclusion, such that a process, method, article, or device that comprises a multiple elements includes not only those elements but also other elements, or elements that are inherent to such a process, method, item, or device. Without more restrictions, the element defined by the phrase “comprise(s) a/an” does not exclude that there are other identical elements in the process, method, item or device that includes the element. In this specification of the application, if it is mentioned that an action is performed according to an element, it means the meaning of performing the action at least according to the element, and includes two cases: the action is performed only on the basis of the element, and the action is performed based on the element and other elements. Multiple, repeatedly, various, etc., expressions include 2, twice, 2 types, and 2 or more, twice or more, and 2 types or more types.

The term “coupled to” and its derivatives can be used herein. “Coupled” may mean that two or more elements are in direct physical or electrical contact. However, “coupled” may also mean that two or more elements are indirectly in contact with each other, but still cooperate or interact with each other, and may mean that one or more other elements are coupled between elements that are said to be coupled to or connected with each other.

The specification includes combinations of the various embodiments described herein. Separate references to embodiments (such as “an embodiment” or “some embodiments” or “preferred embodiments”) do not necessarily refer to the same embodiment; however, these embodiments are not mutually exclusive unless indicated as mutually exclusive or clearly mutually exclusive by those skilled in the art. It should be noted that unless the context clearly indicates or requires otherwise, the word “or” is used in this specification in a non-exclusive sense.

All documents mentioned in this specification are considered to be included in the disclosure of the present application as a whole, so that they can be used as a basis for modification when necessary. In addition, it should be understood that the above descriptions are only preferred embodiments of this specification, and are not intended to limit the protection scope of this specification. Any modification, equivalent replacement, improvement, etc. made within the spirit and principle of one or more embodiments of this specification should be included in the protection scope of one or more embodiments of this specification.

1. A dynamic power consumption management system, comprising:
an equalization algorithm circuit, a carrier recovery algorithm circuit, and an IQ imbalance algorithm circuit, the equalization algorithm circuit, the carrier recovery algorithm circuit, and the IQ imbalance algorithm circuit being sequentially connected and forming a main data path;
an equalization algorithm coefficient update circuit connected to an output end of the carrier recovery algorithm circuit and configured to provide equalization algorithm update coefficients to the equalization algorithm circuit;
a carrier recovery frequency offset and phase noise calculation circuit connected to an output end of the equalization algorithm circuit and configured to provide carrier recovery frequency offset and phase noise coefficients to the carrier recovery algorithm circuit;
an IQ imbalance algorithm coefficient update circuit connected to an output end of the IQ imbalance algorithm circuit and configured to provide IQ imbalance algorithm coefficients to the IQ imbalance algorithm circuit;
a signal-to-noise ratio reporting circuit connected to the output end of the IQ imbalance algorithm circuit and acquires a signal-to-noise ratio of the entire system; and
a management circuit which is coupled to the signal-to-noise ratio reporting circuit, the equalization algorithm coefficient update circuit, the carrier recovery frequency offset and phase noise calculation circuit, and the IQ imbalance algorithm coefficient update circuit, and determines the equalization algorithm update coefficients, the carrier recovery frequency offset and phase noise coefficients, and the IQ imbalance algorithm coefficients based on the signal-to-noise ratio.

2. The dynamic power consumption management system of claim 1, wherein the management circuit determines which preset signal-to-noise ratio threshold range the acquired signal-to-noise ratio falls within, to determine an update strategy as follows:
if the signal-to-noise ratio is greater than a first threshold, the management circuit determines that the equalization algorithm update coefficient is updated every 8 clocks, the IQ imbalance algorithm coefficient is updated every 16 clocks, and the carrier recovery frequency offset and phase noise coefficients are updated every 4 clocks;
if the signal-to-noise ratio is greater than a second threshold and less than or equal to the first threshold, the management circuit determines that the equalization algorithm update coefficient is updated every 6 clocks, the IQ imbalance algorithm coefficient is updated every 12 clocks, and the carrier recovery frequency offset and phase noise coefficients are updated every 3 clocks;
if the signal-to-noise ratio is greater than a third threshold and less than or equal to the second threshold, the management circuit determines that the equalization algorithm update coefficient is updated every 4 clocks, the IQ imbalance algorithm coefficient is updated every 8 clocks, and the carrier recovery frequency offset and phase noise coefficients are updated every 2 clocks; and
if the signal-to-noise ratio is less than the third threshold, the management circuit determines that the equalization algorithm update coefficient is updated every 2 clocks, the IQ imbalance algorithm coefficient is updated every 4 clocks, and the carrier recovery frequency offset and phase noise coefficients are updated every 1 clock.

3. The dynamic power consumption management system of claim 1, wherein the management circuit determines which preset signal-to-noise ratio threshold range the acquired signal-to-noise ratio falls within, to determine an update strategy as follows:
if the signal-to-noise ratio is greater than a first threshold, the management circuit determines that: during the 1st-4th clocks, the equalization algorithm update coefficient is updated every 2 clocks, the IQ imbalance algorithm coefficient is updated every 4 clocks, and the carrier recovery frequency offset and phase noise coefficients are updated every 1 clock; during the 5th-20th clocks, the equalization algorithm update coefficient is updated every 4 clocks, the IQ imbalance algorithm coefficient is updated every 8 clocks, and the carrier recovery frequency offset and phase noise coefficients are updated every 2 clocks; during the 21st-32nd clocks, the equalization algorithm update coefficient is updated every 6 clocks, the IQ imbalance algorithm coefficient is updated every 12 clocks, and the carrier recovery frequency offset and phase noise coefficients are updated every 3 clocks; during the 33rd-48th clocks, the equalization algorithm update coefficient is updated every 8 clocks, the IQ imbalance algorithm coefficient is updated every 16 clocks, and the carrier recovery frequency offset and phase noise coefficients are updated every 4 clocks; and then repeats this sequence cyclically;
if the signal-to-noise ratio is greater than a second threshold and less than or equal to the first threshold, the management circuit determines that: during the 1st-8th clocks, the equalization algorithm update coefficient is updated every 2 clocks, the IQ imbalance algorithm coefficient is updated every 4 clocks, and the carrier recovery frequency offset and phase noise coefficients are updated every 1 clock; during the 9th-16th clocks, the equalization algorithm update coefficient is updated every 4 clocks, the IQ imbalance algorithm coefficient is updated every 8 clocks, and the carrier recovery frequency offset and phase noise coefficients are updated every 2 clocks; during the 17th-28th clocks, the equalization algorithm update coefficient is updated every 6 clocks, the IQ imbalance algorithm coefficient is updated every 12 clocks, and the carrier recovery frequency offset and phase noise coefficients are updated every 3 clocks; during the 29th-44th clocks, the equalization algorithm update coefficient is updated every 8 clocks, the IQ imbalance algorithm coefficient is updated every 16 clocks, and the carrier recovery frequency offset and phase noise coefficients are updated every 4 clocks; and then repeats this sequence cyclically;
if the signal-to-noise ratio is greater than a third threshold and less than or equal to the second threshold, the management circuit determines that: during the 1st-8th clocks the equalization algorithm update coefficient is updated every 2 clocks, the IQ imbalance algorithm coefficient is updated every 4 clocks, and the carrier recovery frequency offset and phase noise coefficients are updated every 1 clock; during the 9th-16th clocks, the equalization algorithm update coefficient is updated every 4 clocks, the IQ imbalance algorithm coefficient is updated every 8 clocks, and the carrier recovery frequency offset and phase noise coefficients are updated every 2 clocks; during the 17th-28th clocks, the equalization algorithm update coefficient is updated every 6 clocks, the IQ imbalance algorithm coefficient is updated every 12 clocks, and the carrier recovery frequency offset and phase noise coefficients are updated every 3 clocks; and then repeats this sequence cyclically; and
if the signal-to-noise ratio is less than the third threshold, the management circuit determines that: during the 1st-8th clocks, the equalization algorithm update coefficient is updated every 2 clocks, the IQ imbalance algorithm coefficient is updated every 4 clocks, and the carrier recovery frequency offset and phase noise coefficients are updated every 1 clock; during the 9th-16th clocks, the equalization algorithm update coefficient is updated every 4 clocks, the IQ imbalance algorithm coefficient is updated every 8 clocks, and the carrier recovery frequency offset and phase noise coefficients are updated every 2 clocks; and then repeats this sequence cyclically.

4. The dynamic power consumption management system of claim 2, further comprising:
a parameter acquisition circuit, configured to acquire sequence BER, DGD, PDL, and SOP of the entire system;
a protection circuit coupled to the parameter acquisition circuit, the signal-to-noise ratio reporting circuit, and the management circuit, wherein if any one of the sequence BER, DGD, PDL, and SOP is greater than a corresponding threshold, or the signal-to-noise ratio is less than a corresponding threshold, or an absolute value of a difference between two consecutive measured values of any one of the signal-to-noise ratio, the sequence BER, DGD, PDL, and SOP is greater than a corresponding threshold, the protection circuit deactivates the management circuit; and if each of the sequence BER, DGD, PDL, and SOP is less than or equal to a corresponding threshold, and the signal-to-noise ratio is greater than or equal to a corresponding threshold, and the absolute value of the difference between two consecutive measured values of any one of the signal-to-noise ratio, the sequence BER, DGD, PDL, and SOP is less than or equal to a corresponding threshold, the protection circuit activates the management circuit.

5. The dynamic power consumption management system of claim 1, wherein the equalization algorithm coefficient update circuit performs updating based on the equalization algorithm update coefficient determined by the management circuit, and is deactivated during clock cycles when not updating.

6. The dynamic power consumption management system of claim 1, wherein the IQ imbalance algorithm coefficient update circuit performs updating based on the IQ imbalance algorithm coefficient determined by the management circuit, and is deactivated during clock cycles when not updating.

7. The dynamic power consumption management system of claim 1, wherein the carrier recovery frequency offset and phase noise calculation circuit performs updating based on the frequency offset and phase noise coefficients determined by the management circuit, and provides the phase noise coefficients by using a linear interpolation method during clock cycles when not updating.
